(19) United States
(12) Patent Application Publication
(10) Pub. No.: US 2020/0395579 A1
(43) Pub. Date: Dec. 17, 2020

(54) ENERGY STORAGE DEVICE

(71) Applicant: GS Yuasa International Ltd., Kyoto-shi (JP)

(72) Inventors: Hironori ICHINOHASHI, Kyoto-shi, Kyoto (JP); Yudai KATO, Kyoto-shi, Kyoto (JP); Yusuke OGAWA, Kyoto-shi, Kyoto (JP)

(21) Appl. No.: 16/957,025

(22) PCT Filed: Dec. 21, 2018
(86) PCT No.: PCT/JP2018/047208

§ 371 Date: Jun. 22, 2020

(30) Foreign Application Priority Data
Dec. 27, 2017 (JP) 2017-250892

(51) Int. Cl. H01M 2/02; H01M 2/04; H01G 11/78; H01G 11/22

(52) U.S. Cl. CPC H01M 2/028; H01G 11/22; H01G 11/78; H01M 2/04

(57) ABSTRACT

An energy storage device includes an electrode assembly, a case body containing the electrode assembly, a lid structure having a lid body closing the case body, and an insulating member disposed around the electrode assembly in the case body. In this energy storage device, one of the lid structure and a side spacer includes a space along an insertion direction with respect to the case body, and the other of the lid structure and the insulating member has a fitting portion which is abutted against the one of the lid structure and the insulating member in each of the insertion direction and an opposite direction of the insertion direction in the space and fitted in the space.

### TECHNICAL FIELD

The present invention relates to an energy storage device including an insulating member disposed around an electrode assembly.

### BACKGROUND ART

Conventionally, as an energy storage device, an energy storage device assembled by inserting a spacer, which is an insulating member, into a case while the spacer is attached to an electrode assembly is known (for example, see Patent Document 1).

### PRIOR ART DOCUMENT

### Patent Document

Patent Document 1: JP-A-2011-216239

### SUMMARY OF THE INVENTION

### Problems to be Solved by the Invention

When the energy storage device is assembled, the electrode assembly is inserted into a case body in a state where a lid body and the spacer are previously assembled to the electrode assembly. At this time, since the spacer and the lid body are attached via the electrode assembly, there is a possibility that positional misalignment occurs between the spacer and the lid body. Specifically, when the electrode assembly is inserted into the case body, the spacer becomes unsteady with respect to the lid body, which hinders a smooth assembly operation.

Thus, an object of the present invention is to provide an energy storage device which enables a smooth assembly operation.

### Means for Solving the Problems

An energy storage device according to one aspect of the present invention includes an electrode assembly, a case body containing the electrode assembly, a lid structure having a lid body closing the case body, and an insulating member disposed around the electrode assembly in the case body. In this energy storage device, one of the lid structure and the insulating member includes a space along an insertion direction with respect to the case body, and the other of the lid structure and the insulating member has a fitting portion which is abutted against the one of the lid structure and the insulating member in each of the insertion direction and an opposite direction of the insertion direction in the space and fitted in the space.

### Advantages of the Invention

The present invention can provide an energy storage device which enables a smooth assembly operation.

### BRIEF DESCRIPTION OF THE DRAWINGS

FIG. 1 is a perspective view showing an external appearance of an energy storage device according to an embodiment.

FIG. 2 is an exploded perspective view of the energy storage device according to the embodiment.

FIG. 3 is an exploded perspective view of a part of the energy storage device according to the embodiment excluding a case body and an insulating sheet.

FIG. 4 is a side view showing a schematic configuration of a side spacer according to the embodiment.

FIG. 5 is a plan view showing a schematic configuration of the side spacer according to the embodiment.

FIG. 6 is a plan view showing a schematic configuration of the side spacer according to the embodiment.

FIG. 7 is a front view showing a positional relationship among the side spacer, an electrode assembly, and the insulating sheet according to the embodiment.

FIG. 8 is a cross-sectional view showing a positional relationship among the side spacer, the case body, and the insulating sheet according to the embodiment.

FIG. 9 is a cross-sectional view showing a positional relationship among the side spacer, the electrode assembly, and a lid structure according to the embodiment.

FIG. 10 is an explanatory view showing a joining region between the insulating sheet and the side spacer according to the embodiment.

FIG. 11 is a front view showing a positional relationship among the side spacer, the electrode assembly, and the insulating sheet according to Modification Example 1.

FIG. 12 is a cross-sectional view showing a state before assembling a lower gasket according to Modification Example 2 and members around the lower gasket.

FIG. 13 is a cross-sectional view showing a state after assembling the lower gasket according to Modification Example 2 and the members around the lower gasket.

FIG. 14 is an enlarged cross-sectional view showing a part of a side spacer according to Modification Example 3.

### MODE FOR CARRYING OUT THE INVENTION

In order to achieve the above object, an energy storage device according to one aspect of the present invention includes an electrode assembly, a case body containing the electrode assembly, a lid structure having a lid body closing the case body, and an insulating member disposed around the electrode assembly in the case body. In this energy storage device, one of the lid structure and the insulating member includes a space along an insertion direction with respect to the case body, and the other of the lid structure and the insulating member has a fitting portion which is abutted against the one of the lid structure and the insulating member in each of the insertion direction and an opposite direction of the insertion direction in the space and fitted in the space.

According to this, since the fitting portion is fitted in the space, movement of the insulating member in the insertion direction and its opposite direction is restricted. Thus, the insulating member is positioned in the insertion direction with respect to the lid structure and its opposite direction. Accordingly, during assembling, the insulating member is less likely to be unsteady with respect to the lid structure, and an assembly operation can be performed smoothly.

The electrode assembly may be fixed to the insulating member.

According to this, since the electrode assembly is fixed to the insulating member, the insulating member and the electrode assembly are positioned. As described above, since the insulating member and the lid structure are also positioned, the electrode assembly is indirectly positioned with respect to the lid structure.

When the electrode assembly has a bundling portion (tab portion) and the bundling portion is joined to a current collector incorporated in the lid structure, the electrode assembly is held by the lid structure via the bundling portion and is therefore in an unstable state. However, if the electrode assembly is indirectly positioned with respect to the lid structure via the insulating member, the electrode assembly can be held stably as compared with a case where the electrode assembly is held by the lid structure only via the bundling portion. Accordingly, the electrode assembly can be positioned at an accurate position even during assembly without receiving a restraining force from the case body. This enables a smooth assembly operation.

A proximal end of the fitting portion may be thicker than a distal end fitted in the space.

If the fitting portion has a uniform thickness matching the space, the fitting portion may be bent when inserted into the case body in a state where the lid structure, the insulating member, and the electrode assembly are assembled. However, if the proximal end of the fitting portion is thicker than the distal end, strength of the proximal end can be increased, and bending of the fitting portion during insertion can be suppressed. Accordingly, the assembly operation can be performed more smoothly.

The energy storage device further includes a current collector electrically connected to the electrode assembly, and the lid structure includes an insulator which insulates the lid body and the current collector. The space is provided between the lid body and the insulator in the lid structure. The insulating member is provided with the fitting portion, and the fitting portion may be sandwiched between the lid body and the insulator in the space.

According to this, even in the case of the lid structure having the insulator, the insulating member can be positioned by fitting the fitting portion in the space formed between the lid body and the insulator. Since the fitting portion is sandwiched between the lid body and the insulator in the space of the lid structure, it is possible to permit the fitting portion to have a simple shape.

The insulating member includes a main body portion facing a side surface of the electrode assembly and having the fitting portion protruding from one end on a side of the lid structure, and the fitting portion may have an abutment portion abutted against the lid structure in a protruding direction of the fitting portion.

According to this, since the abutment portion is abutted against the lid structure in the protruding direction of the fitting portion, the insulating member and the lid structure can be positioned in the protruding direction. Consequently, the insulating member and the lid structure are positioned in the insertion direction, the opposite direction, and the protruding direction, so that a smoother assembly operation can be performed.

In a state in which the fitting portion is not fitted in the space, a nipping surface of the insulator, which nips the fitting portion with the lid body, may be inclined with respect to the insertion direction with an inclination where the space becomes smaller toward a distal end.

According to this, in the state in which the fitting portion is not fitted in the space, the nipping surface of the insulator is inclined with the inclination where the space becomes smaller toward the distal end, so that when the fitting portion is fitted in the space, the nipping surface is pushed in a direction in which the nipping surface separates from the lid body. That is, since the insulator is elastically deformed, a restoring force of the insulator acts on the fitting portion after the fitting, and the fitting portion is pressed against the lid body. Consequently, during assembly, it is possible to more reliably prevent the insulating member from being unsteady with respect to the lid structure.

The nipping surface of the insulator, which nips the fitting portion with the lid body, may nip the fitting portion with an inclination where the nipping surface approaches the lid body toward the distal end.

Since the nipping surface of the insulator, which nips the fitting portion with the lid body, nips the fitting portion with the inclination where the nipping surface approaches the lid body toward the distal end, the fitting portion of the insulating member is less likely to fall out of the space, and unsteadiness can be further suppressed.

Hereinafter, an energy storage device according to an embodiment of the present invention and a modification example thereof will be described with reference to the drawings. The embodiment and the modification example thereof described below may show a general or specific example. The values, shapes, materials, constituent elements, layout and connection of the constituent elements, manufacturing steps, and the order of the manufacturing steps in the embodiment and the modification example thereof are given not for limiting the present invention but merely for illustrative purposes only. Among the constituent elements in the embodiment and the modification example thereof, constituent elements not recited in any one of the independent claims are described as arbitrary constituent elements. The drawings are schematic representations, and thus are not necessarily true to scale.

In the following description and drawings, a direction in which a pair of electrode terminals of the energy storage device are arranged, a direction in which a pair of bundling portions of the electrode assembly are arranged, or a direction facing a short side surface of a case is defined as an X-axis direction. A direction facing a long side surface of the case, a lateral direction of the short side surface of the case, a thickness direction of the case, or a stack direction of electrode plates of the electrode assembly is defined as a Y-axis direction. A direction in which the case body and a lid body of the energy storage device are arranged, a longitudinal direction of the short side surface of the case, an axial direction of a shaft of the electrode terminal, or a vertical direction is defined as a Z-axis direction. The X-axis direction, Y-axis direction, and Z-axis direction are directions intersecting each other (orthogonal to each other in the present embodiment). Although a case is considered in which the Z-axis direction is not the vertical direction depending on the mode of use thereof, the Z-axis direction will be described below as the vertical direction for convenience of explanation. In the following description, for example, a plus side in the X-axis direction indicates an arrow direction side of the X-axis, and a minus side in the X-axis direction indicates a side opposite to the plus side in the X-axis direction. The same applies to the Y-axis direction and the Z-axis direction.

### Embodiment

### 1. Configuration of Energy Storage Device

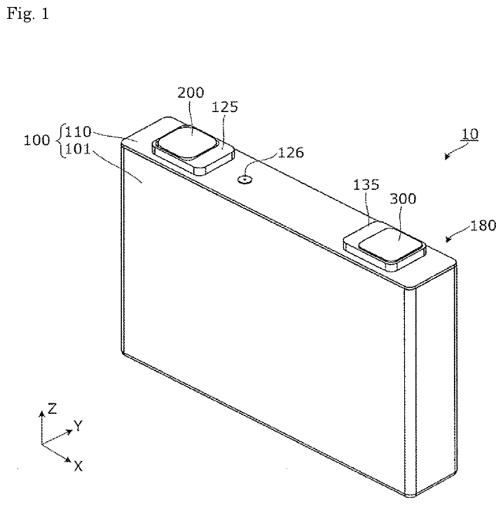

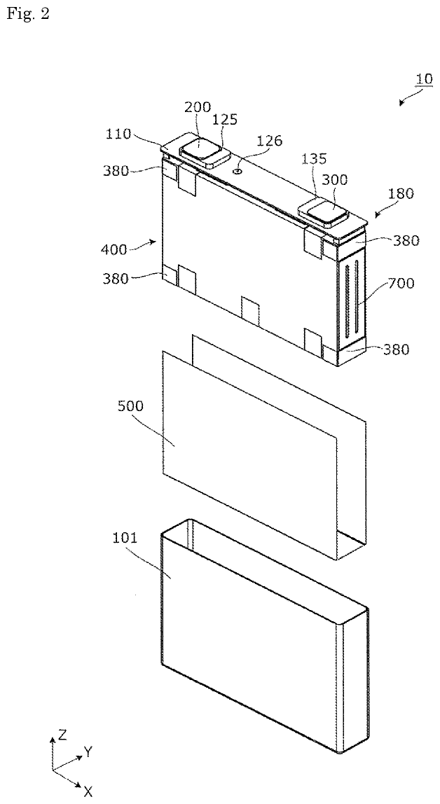

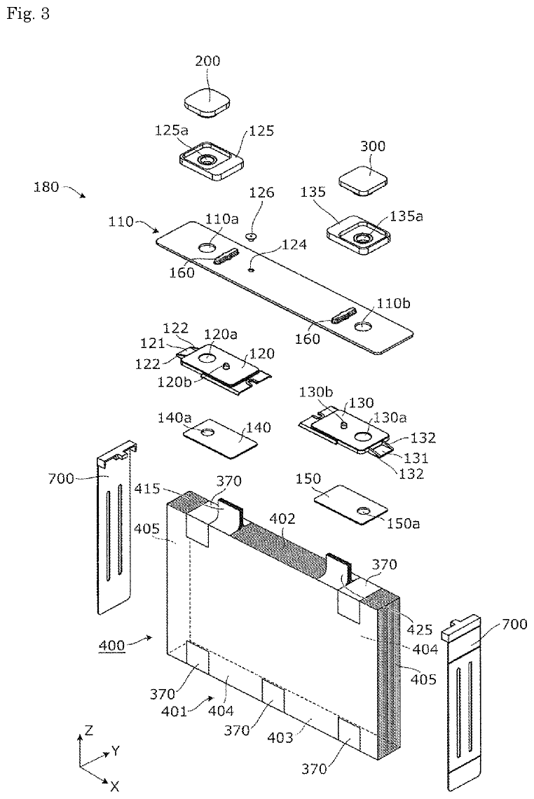

First, a general description of an energy storage device 10 in the present embodiment will be given with reference to FIGS. 1 to 3. FIG. 1 is a perspective view showing an external appearance of the energy storage device 10 according to the embodiment. FIG. 2 is an exploded perspective view of the energy storage device 10 according to the embodiment. FIG. 3 is an exploded perspective view of a part of the energy storage device 10 according to the embodiment excluding a case body 101 and an insulating sheet 500.

The energy storage device 10 is a secondary battery capable of charging and discharging electricity and specifically is a nonaqueous electrolyte secondary battery such as a lithium ion secondary battery. The energy storage device 10 is applied to, for example, a power supply for a vehicle (or a moving object), such as an electric vehicle (EV), a hybrid electric vehicle (HEV), or a plug-in hybrid electric vehicle (PHEV), a power supply for an electronic device, or a power supply for power storage. The energy storage device 10 is not limited to a nonaqueous electrolyte secondary battery, and may be a secondary battery other than the nonaqueous electrolyte secondary battery, or a capacitor. The energy storage device 10 may be a primary battery that can use stored electricity even when a user does not perform charging. The energy storage device 10 may be an all-solid-state battery.

As shown in these drawings, the energy storage device 10 includes a case 100, an electrode assembly 400, an insulating sheet 500, and a pair of side spacers 700. An electrolyte solution (nonaqueous electrolyte) is sealed in the case 100, but is not shown in the drawings. The type of the electrolyte solution is not particularly limited as long as performance of the energy storage device 10 is not impaired, and various types can be selected.

In the present embodiment, a lid structure 180 configured by arranging various elements on a lid body 110 of the case 100 is disposed above the electrode assembly 400. In the case 100, one end of the electrode assembly 400 faces the lid structure 180.

The case 100 is constituted of a case main body 101 having a rectangular cylindrical shape and having a bottom, and the lid body 110 closing an opening of the case body 101. The case 100 contains the electrode assembly 400, the insulating sheet 500, and the pair of side spacers 700. The container 100 has a structure in which the lid body 110 and the case body 101 are welded or the like after the electrode assembly 400 and the like are contained inside, so that the inside is sealed. The case 100 (the lid body 110 and the case body 101) may be formed of a weldable metal such as stainless steel, aluminum, or an aluminum alloy. The lid body 110 and the case body 101 are preferably formed of the same material, but may be formed of different materials. The lid body 110 is provided with an electrolyte solution filling port 124 for injecting the electrolyte solution into the case 100. The electrolyte solution filling port 124 is closed by an electrolyte solution filling plug 126. In the lid body 110, a gas release valve or the like which discharges gas inside the case 100 when internal pressure of the case 100 increases, or the like may be disposed.

The lid structure 180 has the lid body 110 of the case 100, a positive electrode terminal 200, a negative electrode terminal 300, upper gaskets 125 and 135, lower gaskets 120 and 130, a positive electrode current collector 140, and a negative electrode current collector 150.

The lid body 110 is a plate-like member, and as shown in FIG. 3, the lid body 110 is formed with the electrolyte solution filling port 124, through-holes 110a and 110b, and two bulging portions 160. The electrolyte solution filling port 124 is a through-hole for injecting the electrolyte solution when the energy storage device 10 is manufactured. In the present embodiment, each of the two bulging portions 160 is provided on the lid body 110 by forming a part of the lid body 110 in a bulging shape and may be used for positioning the upper gaskets 125 and 135. A recess (not shown) which is a concave portion is formed in an upper portion on a back side of the bulging portion 160 (side facing the electrode assembly 400), and engagement protrusion 120b or 130b of the lower gasket 120 or 130 is engaged with a part of the recess. Consequently, the lower gaskets 120 and 130 are positioned to be fixed to the lid body 110 in the positioned state.

The upper gaskets 125 and 135 and the lower gaskets 120 and 130 are insulators and may be formed of an insulating resin such as polypropylene (PP), polyethylene (PE), or polyphenylene sulfide resin (PPS).

The upper gasket 125 is a member for electrically insulating the positive electrode terminal 200 and the lid body 110 from each other. The upper gasket 125 has a through-hole 125a through which a fastening portion of the positive electrode terminal 200 penetrates. The lower gasket 120 is a member for electrically insulating the positive electrode current collector 140 and the lid body 110 from each other. The lower gasket 120 has a through-hole 120a through which the fastening portion of the positive electrode terminal 200 penetrates.

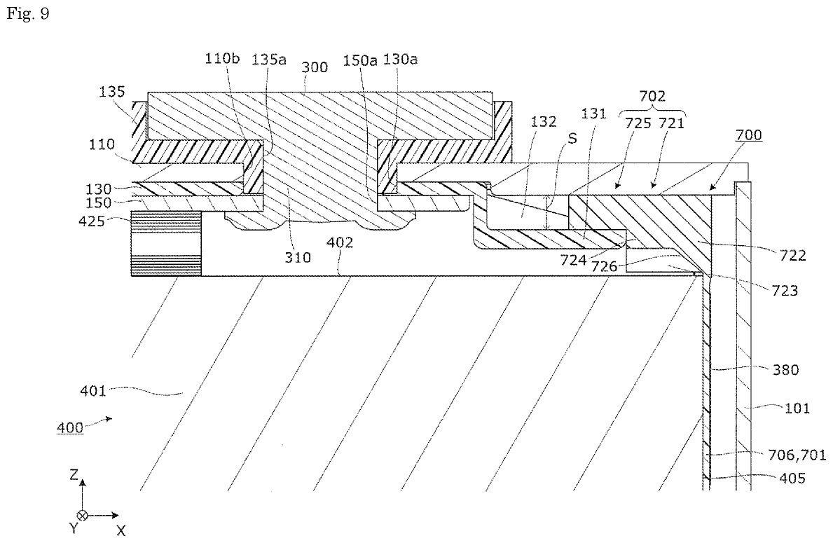

The upper gasket 135 is a member for electrically insulating the negative electrode terminal 300 and the lid body 110 from each other. The upper gasket 135 has a through-hole 135a through which a fastening portion 310 (see FIG. 9) of the negative electrode terminal 300 penetrates. The lower gasket 130 is a member for electrically insulating the negative electrode current collector 150 and the lid body 110 from each other. The lower gasket 130 has a through-hole 130a through which the fastening portion 310 of the negative electrode terminal 300 penetrates.

The upper gaskets 125 and 135 may be referred to as upper packing, and the lower gaskets 120 and 130 may be referred to as lower packing. That is, in the present embodiment, the upper gaskets 125 and 135 have a function of sealing between the electrode terminal (200 or 300) and the case 100. The lower gaskets 120 and 130 may also have a function of sealing between the electrode terminal (200 or 300) and the case 100.

The lower gaskets 120 and 130 are provided with engagement portions 121 and 131 engaged with the side spacer 700. Specifically, the engagement portions 121 and 131 protrude outward in the X-axis direction from the respective outer ends of the lower gaskets 120 and 130. Reinforcing ribs 122 and 132 are provided upright on both side portions of the engaging portions 121 and 131 in the Y-axis direction. The reinforcing ribs 122 and 132 are inclined such that the height decreases toward tips of the engaging portions 121 and 131. The reinforcing ribs 122 and 132 increase strength of the engaging portions 121 and 131.

The engagement of the engaging portions 121 and 131 with the side spacer 700 determines the positions of the lower gaskets 120 and 130 with respect to the side spacer 700. Consequently, the position of the lid structure 180 with respect to the side spacer 700 is determined. A positional relationship during engagement between the engaging portions 121 and 131 and the side spacer 700 will be described later.

As shown in FIG. 1 to FIG. 3, the positive electrode terminal 200 is an electrode terminal electrically connected to a positive electrode of the electrode assembly 400 via the positive electrode current collector 140. The negative electrode terminal 300 is an electrode terminal electrically connected to a negative electrode of the electrode assembly 400 via the negative electrode current collector 150. That is, the positive electrode terminal 200 and the negative electrode terminal 300 are metallic electrode terminals for leading electricity stored in the electrode assembly 400 out of the energy storage device 10 and guiding electricity into the energy storage device 10 to be stored in the electrode assembly 400. The positive electrode terminal 200 is formed of aluminum, an aluminum alloy, or the like, and the negative electrode terminal 300 is formed of copper, a copper alloy, or the like.

The positive electrode terminal 200 is provided with a fastening portion for fastening the case 100 and the positive electrode current collector 140. The negative electrode terminal 300 is provided with the fastening portion 310 (see FIG. 9) for fastening the case 100 and the negative electrode current collector 150.

The fastening portion of the positive electrode terminal 200 is a member (rivet) extending downward from the positive electrode terminal 200, and is inserted into a through-hole 140a of the positive electrode current collector 140 and caulked. Specifically, the fastening portion of the positive electrode terminal 200 is inserted into the through-hole 125a of the upper gasket 125, the through-hole 110a of the lid body 110, the through-hole 120a of the lower gasket 120, and the through-hole 140a of the positive electrode current collector 140, and caulked. As a result, the positive electrode terminal 200 and the positive electrode current collector 140 are electrically connected, and the positive electrode current collector 140 is fixed to the lid body 110 together with the positive electrode terminal 200, the upper gasket 125, and the lower gasket 120.

The fastening portion 310 of the negative electrode terminal 300 is a member (rivet) extending downward from the negative electrode terminal 300, and is inserted into a through-hole 150a of the negative electrode current collector 150 and caulked. Specifically, the fastening portion 310 of the negative electrode terminal 300 is inserted into the through-hole 135a of the upper gasket 135, the through-hole 110b of the lid body 110, the through-hole 130a of the lower gasket 130, and the through-hole 150a of the negative electrode current collector 150, and caulked. As a result, the negative electrode terminal 300 and the negative electrode current collector 150 are electrically connected, and the negative electrode current collector 150 is fixed to the lid body 110 together with the negative electrode terminal 300, the upper gasket 135, and the lower gasket 130.

The fastening portion 310 may be formed as an integral unit with the negative electrode terminal 300, and the fastening portion 310 produced as a separate component from the negative electrode terminal 300 may be fixed to the negative electrode terminal 300 by a method such as caulking or welding. The same applies to a relationship between the positive electrode terminal 200 and its fastening portion.

The positive electrode current collector 140 is a member disposed between the electrode assembly 400 and the lid body 110 and electrically connecting the electrode assembly 400 and the positive electrode terminal 200. The positive electrode current collector 140 is formed of aluminum, an aluminum alloy, or the like. The positive electrode current collector 140 has the through-hole 140a through which the fastening portion of the positive electrode terminal 200 penetrates.

The negative electrode current collector 150 is a member disposed between the electrode assembly 400 and the lid body 110 and electrically connecting the electrode assembly 400 and the negative electrode terminal 300. The negative electrode current collector 150 is formed of copper, a copper alloy, or the like. The negative electrode current collector 150 has the through-hole 150a through which the fastening portion 310 of the negative electrode terminal 300 penetrates.

As shown in FIG. 3, the electrode assembly 400 is an energy storage element (power generating element) including a plurality of positive electrode plates, a plurality of negative electrode plates, and a separator and capable of storing electricity, and is positioned inside the case 100. Specifically, the electrode assembly 400 is a stacked electrode assembly in which a positive electrode plate and a negative electrode plate are alternately arranged with a separator interposed therebetween. The positive electrode plate is an electrode plate in which a positive active material layer is formed on a positive electrode substrate layer which is a long belt-shaped current collector foil formed of aluminum, an aluminum alloy, or the like. The negative electrode plate is an electrode plate in which a negative active material layer is formed on a negative electrode substrate layer which is a long belt-shaped current collector foil formed of copper, a copper alloy, or the like. As the current collector foil, known materials such as nickel, iron, stainless steel, titanium, fired carbon, conductive polymer, conductive glass, and Al—Cd alloy may be used as appropriate. As the positive active material and the negative active material used for the positive active material layer and the negative active material layer, known materials can be appropriately used as long as they are active materials capable of storing and releasing lithium ions. As the separator, a microporous sheet including a resin or a nonwoven fabric can be used.

The electrode assembly 400 has an electrode assembly body 401, which is a portion generating and storing electric power, and a positive electrode bundling portion 415 and a negative electrode bundling portion 425 which are portions transmitting the electric power between the electrode assembly body 401 and the outside.

The electrode assembly body 401 is formed in a substantially rectangular parallelepiped shape as a whole. In the electrode assembly body 401, end edges of a plurality of electrode plates are collected to form a surface. More specifically, the electrode assembly body 401 includes a top surface 402 facing the lid body 110, a bottom surface 403 facing a bottom of the case body 101, a pair of first side surfaces 404 adjacent to the top surface 402 and the bottom surface 403 and parallel to an X-Z plane, and a pair of second side surfaces 405 adjacent to the top surface 402 and the bottom surface 403 and parallel to a Y-Z plane. The first side surface 404 and the second side surface 405 are different side surfaces. Specifically, the first side surface 404 is a long side surface having a larger area than the second side surface 405, and the second side surface 405 is a short side surface.

Adhesive tapes 370 are attached at two places to the top surface 402 and the pair of first side surfaces 404 of the electrode assembly body 401. Adhesive tapes 370 are attached at three places to the bottom surface 403 and the pair of first side surfaces 404 of the electrode assembly body 401. These adhesive tapes 370 prevent positional misalignment of the positive electrode plate, the negative electrode plate, and the separator.

The positive electrode bundling portion 415 protrudes from the minus side in the X-axis direction on the top surface 402 of the electrode assembly body 401. The positive electrode bundling portion 415 is formed by bundling portions of each positive electrode plate where the positive active material is not applied and the positive electrode substrate layer is exposed. The negative electrode bundling portion 425 protrudes from the plus side in the X-axis direction on the top surface 402 of the electrode assembly body 401. The negative electrode bundling portion 425 is formed by bundling portions of each negative electrode plate where the negative active material is not applied and the negative electrode substrate layer is exposed.

The positive electrode bundling portion 415 is joined to the positive electrode current collector 140, and the negative electrode bundling portion 425 is joined to the negative electrode current collector 150. That is, the positive electrode bundling portion 415 is electrically connected to the positive electrode terminal 200 through the positive electrode current collector 140, and the negative electrode bundling portion 425 is electrically connected to the negative electrode terminal 300 through the negative electrode current collector 150. Consequently, the electrode assembly 400 can supply and receive electric power to and from an external device or the like via the positive electrode terminal 200 and the negative electrode terminal 300.

A known joining method can be used for joining the bundling portion and the current collector. Examples of the joining method include welding such as ultrasonic welding and laser welding, and fastening such as caulking or screwing.

Next, the side spacer 700 according to the present embodiment will be described.

As shown in FIG. 2, the pair of side spacers 700 are arranged so as to overlap with each of the pair of second side surfaces 405 of the electrode assembly 400. That is, in the case body 101, the pair of side spacers 700 are arranged around the electrode assembly 400. The side spacer 700 is an insulating member formed of an insulating resin such as PP, PE, or PPS. Hereinafter, a specific structure of the side spacer 700 on the negative electrode side of the pair of side spacers 700 will be described. The side spacer 700 on the positive electrode side has the same structure as the side spacer 700 on the negative electrode side, and thus a description thereof will be omitted.

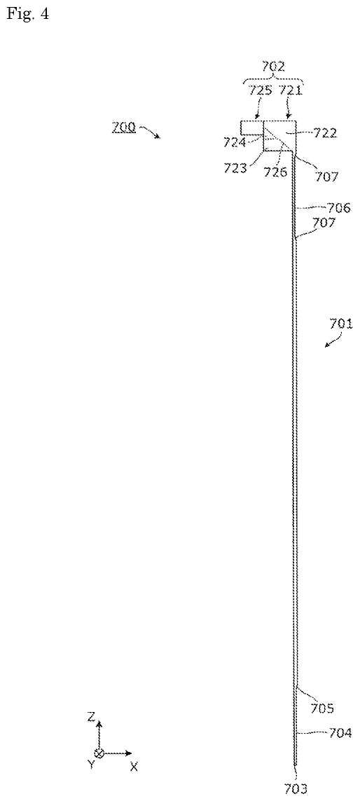

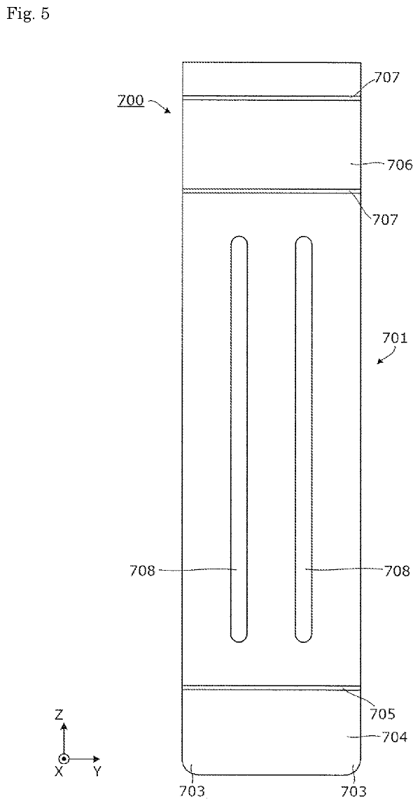

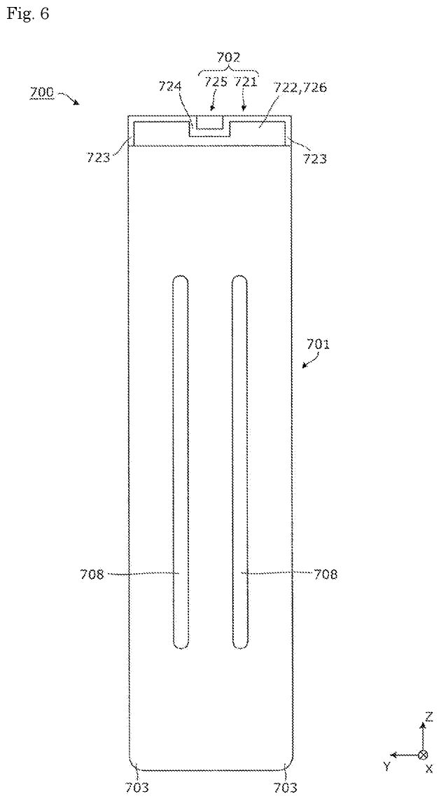

FIG. 4 is a side view showing a schematic configuration of the side spacer 700 according to the embodiment. FIGS. 5 and 6 are plan views showing a schematic configuration of the side spacer 700 according to the embodiment. Specifically, FIG. 4 is a view of the side spacer 700 viewed from the minus side in the Y-axis direction. FIG. 5 is a view of the side spacer 700 viewed from the plus side in the X-axis direction. FIG. 6 is a view of the side spacer 700 viewed from the minus side in the X-axis direction.

As shown in FIGS. 4 to 6, the side spacer 700 is formed in a substantially flat plate shape as a whole. The side spacer 700 includes a main body portion 701 and a fitting portion 702, which are integrally formed.

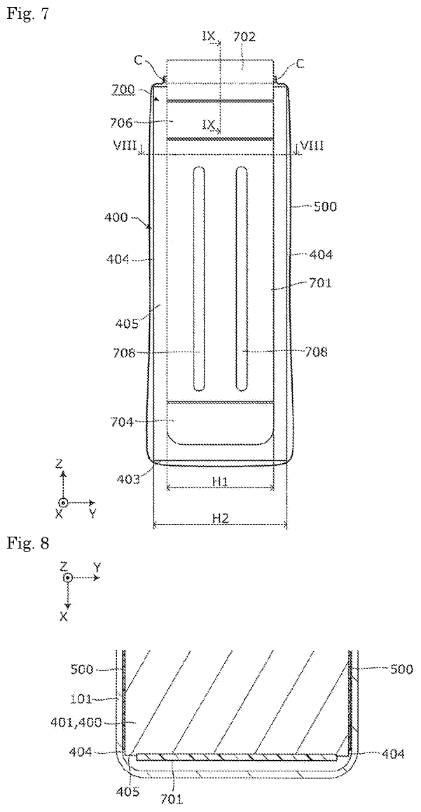

The main body portion 701 is formed in a plate shape and disposed to face the second side surface 405 of the electrode assembly 400. Specifically, the main body portion 701 is formed in a substantially rectangular shape that is long in the Z-axis direction and parallel to the Y-Z plane. A width H1 of the main body portion 701 in the Y-axis direction is smaller than a width H2 of the second side surface 405 of the electrode assembly 400 (see FIG. 7). Specifically, the width H1 of the main body portion 701 is preferably 80% or more and less than 100% of the width of the electrode assembly 400. In the present embodiment, the entire width of the side spacer 700 falls within the width H1.

A pair of corners 703 at a lower end of the main body portion 701 are chamfered. Specifically, the corner 703 is formed in an R shape. The shape of the corner 703 is not limited to an R shape as long as the shape is not sharp at an acute angle. The other shapes of the corner 703 include a C-planar shape. The lower end (the other end) of the main body portion 701 is a thin portion 704 having a smaller thickness than the other portions. The entire thin portion 704 has a uniform thickness in the width direction in the main body portion 701. In a surface of the main body portion 701, which is opposite to the second side surface 405 of the electrode assembly 400, an inclined surface 705 is formed at a boundary between the thin portion 704 and the other portions. Concentration of a stress is suppressed by the inclined surface 705.

From an upper end (one end) of the main body portion 701, the fitting portion 702 protrudes inward of the case body 101. Thus, a protruding direction of the fitting portion 702 is the X-axis direction. Immediately below the upper end of the main body portion 701, a thin portion 706 having a smaller thickness than the other portions is provided. The entire thin portion 706 has a uniform thickness in the width direction in the main body portion 701. In the surface of the main body portion 701, which is opposite to the second side surface 405 of the electrode assembly 400, a pair of inclined surfaces 707 are provided so as to sandwich the thin portion 706 in the Z-axis direction. The pair of inclined surfaces 707 are boundaries between the thin portion 706 and the other portions. The concentration of a stress is suppressed by the pair of inclined surfaces 707.

A pair of slits 708 which are long in the Z-axis direction are provided between a pair of the thin portions 704 and 706. The pair of slits 708 are provided in parallel. Since the second side surface 405 of the electrode assembly 400 is exposed by the pair of slits 708, the electrolyte solution penetrates into the electrode assembly 400 through the slit 708.

The fitting portion 702 includes a proximal end 721 and a distal end 725. The proximal end 721 of the fitting portion 702 includes an inclination portion 722, a pair of wall portions 723, and a holding portion 724. The inclination portion 722 has an inclined surface 726 which increases the thickness as it approaches the lid structure 180. A thickness direction of the inclination portion 722 is the X-axis direction, similarly to the main body portion 701. However, in the inclination portion 722, the thickness direction may be the Z-axis direction. In this case, it can be said that the inclined surface 726 makes the thickness of the inclination portion 722 smaller as it approaches the lid structure 180. The thickness of the inclination portion 722 in both the X-axis direction and the Z-axis direction is larger than the thickness in the X-axis direction of a part of the main body portion 701 other than the fitting portion 702.

The pair of wall portions 723 are provided at both ends of the inclination portion 722 in the Y-axis direction. Specifically, the wall portion 723 projects from the inclined surface 726 of the inclination portion 722. An outer surface formed by the wall portion 723 and the inclination portion 722 is flush, and its side view shape is rectangular. That is, the outer surface has a larger area than an outer surface formed only by the wall portion 723.

The holding portion 724 is a portion for holding the distal end 725. Specifically, the holding portion 724 is provided at the center of the inclination portion 722 in the Y-axis direction. The holding portion 724 projects from the inclined surface 726 of the inclination portion 722, and the distal end 725 protrudes from a distal end surface of the holding portion 724. As shown in FIG. 6, in plan view, the holding portion 724 is formed in a shape and a size that allow the distal end 725 to be fitted as a whole. Specifically, a plan view shape of the holding portion 724 is rectangular, the thickness in the Z-axis direction is larger than the distal end 725, and the width in the Y-axis direction is also larger than the distal end 725.

The distal end 725 is formed in a prismatic shape and protrudes inward of the case 100 from the distal end surface of the holding portion 724. An upper surface of the distal end 725 is flush with an upper surface of the proximal end 721. Each of thickness of the distal end 725 in the X-axis direction and the thickness in the Z-axis direction is larger than the thickness of the main body portion 701 in the X-axis direction.

As described above, in the fitting portion 702, the thickness of each of the proximal end 721 and the distal end 725 is larger than the thickness of the part of the main body portion 701 other than the fitting portion 702. That is, the fitting portion 702 is a thick portion thicker than the other portions of the main body portion 701.

Next, a positional relationship between the side spacer 700 and the other members in the case 100 will be described. FIG. 7 is a front view showing a positional relationship among the side spacer 700, the electrode assembly 400, and the insulating sheet 500 according to the embodiment. FIG. 8 is a cross-sectional view showing a positional relationship among the side spacer 700, the case body 101, and the insulating sheet 500 according to the embodiment. FIG. 9 is a cross-sectional view showing a positional relationship among the side spacer 700, the electrode assembly 400, and the lid structure 180 according to the embodiment. FIG. 8 is a cross-sectional view corresponding to a cross section including section line VIII-VIII in FIG. 7. FIG. 9 is a cross-sectional view corresponding to a cross section including section line IX-IX in FIG. 7. In FIGS. 8 and 9, members not shown in FIG. 7 are also shown.

As shown in FIG. 7, the main body portion 701 of the side spacer 700 is disposed so as to overlap with the second side surface 405 of the electrode assembly 400. The main body portion 701 is accommodated in the second side surface 405 of the electrode assembly 400 in the Y-axis direction (width direction). This is because the width H1 of the side spacer 700 is smaller than the width H2 of the second side surface 405 of the electrode assembly 400. As shown in FIG. 8, an inner corner of the case body 101 is formed in an R shape. However, when the main body portion 701 is accommodated in the second side surface 405 of the electrode assembly 400, the main body portion 701 is spaced apart from the inner corner of the case body 101. Consequently, interference between the inner corner of the case body 101 and the main body portion 701 can be suppressed.

As shown in FIG. 7, the thin portion 704 which is the lower end of the main body portion 701 is located above the bottom surface 403 of the electrode assembly 400. Specifically, a length of the main body portion 701 in the Z-axis direction is preferably 30% or more and less than 100% of a length (height) of the second side surface 405 of the electrode assembly 400 in the Z-axis direction. Consequently, the thin portion 704 of the main body portion 701 is accommodated in the second side surface 405 of the electrode assembly 400 in the Z-axis direction. That is, since the thin portion 704 of the main body portion 701 does not protrude from the electrode assembly 400, interference between the thin portion 704 and the case body 101 can be suppressed.

As shown in FIG. 9, the fitting portion 702 of the side spacer 700 is disposed between the lid body 110 and the electrode assembly 400. In the lid structure 180, a space S along the Z-axis direction is provided between the lid body 110 and the engaging portion 131 of the lower gasket 130. The space S opens on the side spacer 700 side, and the distal end 725 of the fitting portion 702 is inserted into the space S through this open portion. The distal end 725 of the fitting portion 702 is fitted in the lid structure 180 in the Z-axis direction in the space S. That is, the engaging portion 131 and the side spacer 700 are engaged. Specifically, the distal end 725 is abutted directly against the lid body 110 on the plus side in the Z-axis direction and abutted directly against the engaging portion 131 of the lower gasket 130 on the minus side in the Z-axis direction. That is, the distal end 725 is sandwiched between the lid body 110 and the lower gasket 130 in the space S.

The minus side in the Z-axis direction is an insertion direction in which the electrode assembly 400 is inserted into the case body 101. That is, it can be said that the distal end 725 of the fitting portion 702 is abutted against the lid structure 180 in the insertion direction and its opposite direction in the space S, and fitted into the space S. As described above, since the distal end 725 of the fitting portion 702 is fitted in the space S, positional misalignment in the Z-axis direction of the side spacer 700 with respect to the lid structure 180 is suppressed.

The distal end surface of the holding portion 724 of the fitting portion 702 is abutted against the engaging portion 131 of the lower gasket 130 in the X-axis direction. That is, the holding portion 724 is an abutment portion abutted against the lid structure 180 in the protruding direction (the X-axis direction) of the fitting portion 702. Consequently, the side spacer 700 and the lid structure 180 are positioned in the protruding direction.

Lower surfaces of the pair of wall portions 723 face the top surface 402 of the electrode assembly 400. Consequently, even if the side spacer 700 is likely to be bent at a boundary of the fitting portion 702, the pair of wall portions 723 are abutted against the top surface 402 of the electrode assembly 400, and further bending is suppressed.

The side spacer 700 and the electrode assembly 400 are fixed by an adhesive tape 380. For this reason, positional misalignment in the Z-axis direction of the electrode assembly 400 with respect to the lid structure 180 is suppressed by the side spacer 700.

The adhesive tape 380 is applied to the pair of thin portions 704 and 706 of the main body portion 701 (see FIG. 2). Since the adhesive tape 380 is applied to the thin portions 704 and 706 thinner than the other portions of the main body portion 701, the amount of protrusion of the adhesive tape 380 from the main body portion 701 can be suppressed. Accordingly, an installation space for the electrode assembly 400 in the case 100 can be increased, and even when the entire size of the energy storage device 10 is not increased, while an external dimension of the electrode assembly 400 can be increased, energy density can be increased.

As shown in FIG. 7, the insulating sheet 500 is an insulating sheet body covering a part of the electrode assembly 400. Specifically, the insulating sheet 500 covers the pair of first side surfaces 404 and the bottom surface 403 of the electrode assembly 400. Consequently, the insulating sheet 500 has a substantially U shape as a whole. Both ends of the insulating sheet 500 are joined to the side spacer 700.

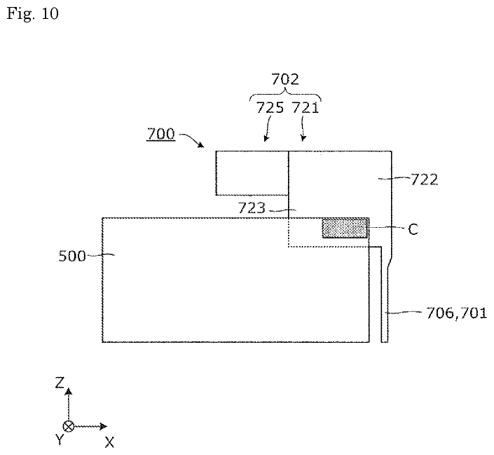

FIG. 10 is an explanatory view showing a joining region C between the insulating sheet 500 and the side spacer 700 according to the embodiment. In FIGS. 7 and 10, the joining region C is illustrated by the mesh pattern.

Specifically, the both ends of the insulating sheet 500 are respectively joined to the pair of wall portions 723 of the side spacer 700. The term “joining” used herein includes adhesion, welding, pressure-sensitive adhesion, and the like. Since the pair of wall portions 723 are arranged above the electrode assembly 400, the insulating sheet 500 can be superposed on the wall portion 723 simply by extending a part of the insulating sheet 500 covering the first side surface 404. Consequently, it is possible to permit the insulating sheet to have a simple shape. The insulating sheet 500 has a long rectangular shape when unfolded. The insulating sheet 500 may be formed of an insulating resin such as PP, PE, or PPS.

### 2. Method of Manufacturing Energy Storage Device

Next, a method of manufacturing the energy storage device 10 will be described. In the following description, a case where a worker assembles the energy storage device 10 is illustrated, but an assembling apparatus may assemble the energy storage device 10.

First, the worker joins the positive electrode current collector 140 to the positive electrode bundling portion 415 of the electrode assembly 400 and also joins the negative electrode current collector 150 to the negative electrode bundling portion 425 of the electrode assembly 400. Thereafter, the worker assembles, on the lid body 110 of the case 100, the positive electrode terminal 200, the negative electrode terminal 300, the upper gaskets 125 and 135, the lower gaskets 120 and 130, the positive electrode current collector 140, and the negative electrode current collector 150. As a result, the electrode assembly 400 and the lid structure 180 are integrated.

Next, the worker attaches the pair of side spacers 700 to the electrode assembly 400. Specifically, the worker places the main body portion 701 on the second side surface 405 of the electrode assembly 400 and inserts the fitting portion 702 into the space S of the lid structure 180. Thereafter, the worker applies the adhesive tape 380 to the thin portions 704 and 706 of each of the side spacers 700 and each of the first side surfaces 404 of the electrode assembly 400, and fixes the pair of side spacers 700 to the electrode assembly 400.

Next, the worker winds the insulating sheet 500 around the electrode assembly 400 so as to cover the bottom surface 403 and the pair of first side surfaces 404 of the electrode assembly 400, and then joins the both ends of the insulating sheet 500 to the fitting portion 702 of the pair of side spacers 700. Consequently, the lid structure 180, the electrode assembly 400, the pair of side spacers 700, and the insulating sheet 500 are integrated.

Next, the worker inserts the integrated lid structure 180, the electrode assembly 400, the pair of side spacers 700, and the insulating sheet 500 into the case body 101. During the insertion, a tension from the bottom surface 403 of the electrode assembly 400 toward the lid structure 180 is generated with respective to the insulating sheet 500. However, the tension hardly acts on the both ends of the insulating sheet 500. That is, during the insertion, the both ends of the insulating sheet 500 are in a state of being hardly peeled off from the side spacer 700, so that smooth insertion is possible. After the insertion, the worker assembles the case 100 by welding the lid body 110 to the case body 101.

Thereafter, the worker fills the case 100 with the electrolyte solution by injecting the electrolyte solution from the electrolyte solution filling port 124. After the injection of the electrolyte solution, as shown in FIG. 1, the worker completes the energy storage device 10 by closing the electrolyte solution filling port 124 with the electrolyte solution filling plug 126.

### 3. Effects, Etc.

As described above, the energy storage device 10 according to the present embodiment includes the electrode assembly 400, the case body 101 containing the electrode assembly 400, the lid structure 180 having the lid body 110 closing the case body 101, and the side spacer 700 (insulating member) disposed around the electrode assembly 400 in the case body 101. In this energy storage device, one of the lid structure 180 and the side spacer 700 includes the space S along the insertion direction with respect to the case body 101, and the other of the lid structure 180 and the side spacer 700 has the fitting portion 702 which is abutted against the one of the lid structure 180 and the side spacer 700 in each of the insertion direction and the opposite direction of the insertion direction in the space S and fitted in the space S.

According to this, since the fitting portion 702 is fitted in the space S, movement of the side spacer 700 in the insertion direction and its opposite direction is restricted. Thus, the side spacer 700 is positioned in the insertion direction with respect to the lid structure 180 and its opposite direction. Accordingly, during assembling, the side spacer 700 is less likely to be unsteady with respect to the lid structure 180, and an assembly operation can be performed smoothly.

The electrode assembly 400 is fixed to the side spacer 700.

According to this, since the electrode assembly 400 is fixed to the side spacer 700, the side spacer 700 and the electrode assembly 400 are positioned. As described above, since the side spacer 700 and the lid structure 180 are also positioned, the electrode assembly 400 is indirectly positioned with respect to the lid structure 180.

In particular, it is suitable for an electrode assembly contained in a state where no reaction force acts on the case body 101, such as the stacked electrode assembly 400 illustrated in the present embodiment, that is, the electrode assembly which is likely to be positionally misaligned in the case body 101.

In the present embodiment, since the electrode assembly 400 is held by the lid structure 180 via the positive electrode bundling portion 415 and the negative electrode bundling portion 425, the electrode assembly 400 is in an unstable state. However, if the electrode assembly 400 is indirectly positioned with respect to the lid structure 180 via the side spacer 700, the electrode assembly 400 can be held stably as compared with a case where the electrode assembly 400 is held by the lid structure 180 only via the positive electrode bundling portion 415 and the negative electrode bundling portion 425. Accordingly, the electrode assembly 400 can be positioned at an accurate position even during assembly without receiving a restraining force from the case body 101. This enables a smooth assembly operation.

In the fitting portion 702, the proximal end 721 is thicker than the distal end 725 fitted in the space S.

If the fitting portion 702 has a uniform thickness matching the space S, the fitting portion 702 may be bent when inserted into the case body 101 in a state where the lid structure 180, the side spacer 700, and the electrode assembly 400 are assembled. However, if the proximal end 721 of the fitting portion 702 is thicker than the distal end 725, strength of the proximal end 721 can be increased, and bending of the fitting portion 702 during insertion can be suppressed. Accordingly, the assembly operation can be performed more smoothly.

The energy storage device 10 further includes the positive electrode current collector 140 and the negative electrode current collector 150 (current collector) electrically connected to the electrode assembly 400. The lid structure 180 includes the lower gaskets 120 and 130 (insulator) which insulate between the lid body 110 and the positive electrode current collector 140 and the negative electrode current collector 150. The space S is provided between the lid body 110 and the lower gaskets 120 and 130 in the lid structure 180. The side spacer 700 includes the fitting portion 702, and the fitting portion 702 is sandwiched between the lid body 110 and the lower gaskets 120 and 130 in the space S.

According to this, even in the case of the lid structure 180 having the lower gaskets 120 and 130, the side spacer 700 can be positioned by fitting the fitting portion 702 in the space S formed between the lid body 110 and the lower gaskets 120 and 130. Since the fitting portion 702 is sandwiched between the lid body 110 and the lower gaskets 120 and 130 in the space S of the lid structure 180, it is possible to permit the fitting portion 702 to have a simple shape.

The side spacer 700 includes the main body portion 701 facing the second side surface 405 of the electrode assembly 400 and having the fitting portion 702 protruding from one end on the lid structure 180 side, and the fitting portion 702 has a holding portion 724 (abutment portion) abutted against the lid structure 180 in the protruding direction of the fitting portion 702.

According to this, since the holding portion 724 is abutted against the lid structure 180 in the protruding direction of the fitting portion 702, the side spacer 700 and the lid structure 180 can be positioned in the protruding direction. Consequently, the side spacer 700 and the lid structure 180 are positioned in the insertion direction, its opposite direction, and the protruding direction, so that a smoother assembly operation can be performed.

### 4. Modification Example

### Modification Example 1

Although the energy storage device 10 according to the above embodiment has been described above, the energy storage device 10 may include an insulating sheet different from the above-described aspect. Thus, Modification Example 1 of the insulating sheet included in the energy storage device 10 will be described below, focusing on differences from the above embodiment. In the following description, the same components as those in the above embodiment are denoted by the same reference numerals, and the description thereof may be omitted.

In the above embodiment, the case where the insulating sheet 500 has a long rectangular shape when unfolded is illustrated. However, in Modification Example 1, a case where protruding pieces 501 are provided at both ends of an insulating sheet 500A is illustrated.

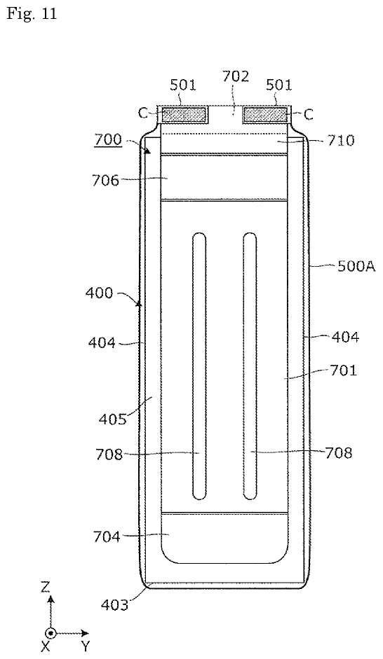

FIG. 11 is a front view showing a positional relationship among the side spacer 700, the electrode assembly 400, and the insulating sheet 500A according to Modification Example 1. Specifically, FIG. 11 is a view corresponding to FIG. 7. As shown in FIG. 11, the protruding pieces 501 are provided at the both ends of the insulating sheet 500A. Although not shown, the protruding pieces 501 are provided at the both ends of the insulating sheet 500A even on the positive electrode side.

The protruding piece 501 is joined to an outer surface 710 of the side spacer 700, which is opposite to the second side surface 405 of the electrode assembly 400. Specifically, the protruding piece 501 is joined to an end of the outer surface 710 on the lid structure 180 side. The outer surface 710 is a surface of the side spacer 700, which faces the inner surface of the case body 101.

The protruding pieces 501 have a rectangular shape and protrude outward from the both ends of the insulating sheet 500A along the X-axis direction before joining. The protruding piece 501 is bent and superposed on the outer surface 710 of the side spacer 700 to join the protruding piece 501 to the outer surface 710. Since the outer surface 710 of the side spacer 700 has a larger surface area than the fitting portion 702, it is possible to increase the joining region C.

### Modification Example 2

The energy storage device 10 may include a lower gasket (insulator) different from the above-described aspect. Thus, Modification Example 2 of the lower gasket included in the energy storage device 10 will be described below, focusing on differences from the above embodiment. In the following description, the same components as those in the above embodiment are denoted by the same reference numerals, and the description thereof may be omitted.

In the lower gasket 130 according to the above embodiment, in a state where the fitting portion 702 is not fitted in the space S, the engaging portion 131 protrudes in the X-axis direction so that the space S becomes equal in the X-axis direction. In Modification Example 2, a lower gasket provided with an engaging portion which displaces a space in the X-axis direction will be described.

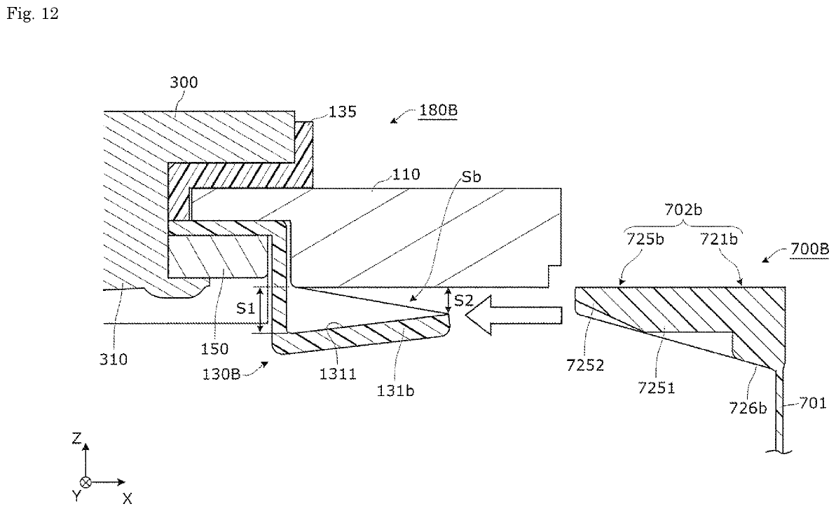

FIG. 12 is a cross-sectional view showing a state before assembling a lower gasket 130B according to Modification Example 2 and members around the lower gasket 130B.

As shown in FIG. 12, an engaging portion 131b of the lower gasket 130B is formed to have a uniform thickness as a whole. The engaging portion 131b is inclined and protrudes toward the plus side in the Z-axis direction as it goes from one end of the lower gasket 130B toward the plus side in the X-axis direction. In other words, the engaging portion 131b is inclined and protrudes so as to approach the lid body 110 as it separates from the negative electrode terminal 300. A main surface of the engaging portion 131b facing the lid body 110 is a nipping surface 1311 which nips a fitting portion 702b of a side spacer 700B with the lid body 110. That is, the nipping surface 1311 is an inclined surface corresponding to an inclination of the engaging portion 131b itself. Specifically, the nipping surface 1311 is inclined toward the plus side in the Z-axis direction as it goes toward the plus side in the X-axis direction. Consequently, at a base portion (end on the minus side in the X-axis direction) of the nipping surface 1311, a space S1 formed with the lid body 110 is the largest, and at a distal end of the nipping surface 1311 (end on the plus side in the X-axis direction), a space S2 formed with the lid body 110 is the smallest. As described above, the nipping surface 1311 is inclined with respect to the Z-axis direction (insertion direction) with an inclination where a space Sb becomes smaller toward the distal end. In the present modification example, the case where the engaging portion 131b has a uniform thickness and is inclined as a whole is illustrated. However, if only the nipping surface 1311 of the engaging portion 131b is inclined, the engaging portion 131b may have any shape. The nipping surface 1311 may be a flat surface or a curved surface.

Next, the fitting portion 702b of the side spacer 700B according to Modification Example 2 will be described.

As shown in FIG. 12, the fitting portion 702b includes a proximal end 721b and a distal end 725b.

The proximal end 721b of the fitting portion 702b includes an inclined surface 726b which increases the thickness in the X-axis direction as it approaches a lid structure 180B. A thickness direction of the proximal end 721b is the X-axis direction, similarly to the main body portion 701. The proximal end 721b is a portion for holding the distal end 725b. Specifically, the distal end 725b protrudes from a distal end surface of the proximal end 721b.

The distal end 725b includes a first portion 7251 and a second portion 7252. The first portion 7251 is a part of the distal end 725b on the plus side in the X-axis direction and is connected to the distal end surface of the proximal end 721b. In the first portion 7251, the thickness in the Z-axis direction is uniformly formed as a whole. The thickness of the first portion 7251 is a thickness corresponding to the space S1. The second portion 7252 is a part of the distal end 725b on the minus side in the X-axis direction and is formed continuously from a distal end surface of the first portion 7251. An upper surface of the second portion 7252 is flush with an upper surface of the first portion 7251. A lower surface of the second portion 7252 is inclined so that the thickness in the Z-axis direction is tapered. The thickness in the Z-axis direction at a distal end of the second portion 7252 is smaller than the space S1.

Next, assembly of the lower gasket 130B and the side spacer 700B according to Modification Example 2 will be described. First, the second portion 7252 of the distal end 725b of the side spacer 700B is inserted into the space S1, formed between the lid body 110 and the engaging portion 131b, from the plus side in the X-axis direction. As the insertion proceeds, the nipping surface 1311 of the engaging portion 131b is gradually pushed toward the minus side in the Z-axis direction by a lower surface of the first portion 7251. Since the lower surface of the second portion 7252 is inclined so as to be tapered, the insertion can be performed smoothly.

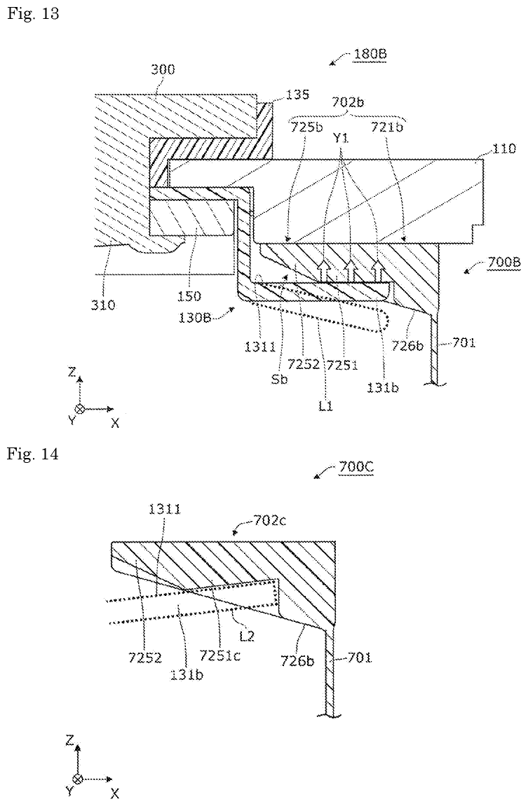

When the nipping surface 1311 is pushed toward the minus side in the Z-axis direction, the engaging portion 131b of the lower gasket 130B is elastically deformed. When the insertion proceeds further and the lower surface of the first portion 7251 is abutted directly against the nipping surface 1311, the second portion 7252 is abutted directly against the lid body 110 on the plus side in the Z-axis direction. That is, the second portion 7252 of the fitting portion 702b is sandwiched between the lid body 110 and the lower gasket 130B in the space Sb and fitted in the space Sb (see FIG. 13).

FIG. 13 is a cross-sectional view showing a state after assembling the lower gasket 130B according to Modification Example 2 and members around the lower gasket 130B. As shown in FIG. 13, after assembly, a restoring force (see arrow Y1) from the engaging portion 131B acts on the second portion 7252 of the side spacer 700B, so that the second portion 7252 is held back against the lid body 110. Consequently, when the electrode assembly 400 is inserted into the case body 101, it is possible to more reliably prevent the side spacer 700B from being unsteady with respect to the lid structure 180B.

A broken line L1 in FIG. 13 virtually indicates an engaging portion inclined to the opposite side to the engaging portion 131b according to Modification Example 2. In the engaging portion having such an inclination, even after assembly, the restoring force of the engaging portion does not act on the side spacer 700B, so that unsteadiness cannot be suppressed.

As described above, in a state where the fitting portion 702b is not fitted in the space Sb, the nipping surface 1311 of the lower gasket 130B, which nips the fitting portion 702b with the lid body 110 is inclined with respect to the insertion direction with an inclination where the space Sb becomes smaller toward the distal end.

According to this, in a state where the fitting portion 702b is not fitted in the space Sb, the nipping surface 1311 of the lower gasket 130B is inclined with the inclination where the space Sb becomes smaller toward the distal end, so that when the fitting portion 702b is fitted in the space Sb, the nipping surface 1311 is pushed in a direction in which the nipping surface 1311 separates from the lid body 110. That is, since the lower gasket 130B is elastically deformed, the restoring force of the lower gasket 130B acts on the fitting portion 702b after the fitting, and the fitting portion 702b is pressed against the lid body 110. Consequently, during assembly, it is possible to more reliably prevent the side spacer 700B from being unsteady with respect to the lid structure 180B.

### Modification Example 3

In Modification Example 2, the case where the thickness of the first portion 7251 of the side spacer 700B in the Z-axis direction is uniformly formed as a whole is illustrated. However, the thickness of the first portion may be non-uniform.

FIG. 14 is an enlarged cross-sectional view showing a part of a side spacer 700C according to Modification Example 3. As shown in FIG. 14, a lower surface of the first portion 7251c of the side spacer 700C is inclined so that the thickness in the Z-axis direction is flared. In other words, the lower surface of the first portion 7251c of the side spacer 700C is inclined so as to approach the lid body 110 from the distal end to the proximal end of the fitting portion 702b.

A broken line L2 in FIG. 14 shows the engaging portion 131B in a state in which the side spacer 700C is assembled. After assembly, the engaging portion 131B is inclined along the lower surface of the first portion 7251c of the side spacer 700C. That is, the nipping surface 1311 of the engaging portion 131B nips the fitting portion 702c with an inclination where the nipping surface 1311 approaches the lid body 110 toward the distal end.

If the lower surface of the first portion 7251c is inclined with the above-described inclination before assembly, the inclined surface 1311 can be inclined even after assembly. Accordingly, the fitting portion 702c of the side spacer 700C is less likely to fall out of the space Sb, and unsteadiness can be further suppressed.

Even in Modification Example 2, in a state in which the side spacer 700B is assembled to the lid structure 180B, the fitting portion 702b may be nipped with an inclination where the nipping surface 1311 approaches the lid body 110 toward the distal end.

### OTHER EMBODIMENTS

The energy storage device according to the present invention has been described above based on the embodiment and the modification examples thereof. However, the present invention is not limited to the above embodiment and modification examples. The scope of the present invention also includes what a person skilled in the art can conceive without departing from the gist of the present invention; for example, various modifications to the above embodiment or modification examples and implementations realized by combining the constituent elements described above.

In the above embodiment, the stacked electrode assembly 400 is illustrated in which the plurality of positive electrode plates and the plurality of negative electrode plates are alternately arranged with the separator interposed therebetween. However, the electrode assembly may be a stacked electrode assembly in which a positive electrode plate and a negative electrode plate are folded in a bellows shape with a separator interposed therebetween. The electrode assembly may be a wound electrode assembly in which a positive electrode plate and a negative electrode plate are wound with a separator interposed therebetween.

In the above embodiment, the case where the side spacer 700 is provided with the fitting portion 702 and the lid structure 180 is provided with the space S is illustrated. However, the side spacer may be provided with the space, and the lid structure may be provided with the fitting portion.

In the above embodiment, the case where the proximal end 721 of the fitting portion 702 is thicker than the distal end 725 is illustrated. However, the proximal end and the distal end of the fitting portion may have a uniform thickness.

In the above embodiment, the case where the space S is provided between the lid body 110 and the lower gaskets 120 and 130 is illustrated. However, the space may be provided in the lid body alone or the lower gasket alone.

In the above embodiment, the case where the fitting portion 702 which is a thick portion protrudes between the electrode assembly 400 and the lid structure 180 is illustrated. However, the thick portion may not protrude between the electrode assembly and the lid structure as long as it is thicker than other portions.

In the above embodiment, the case where the fitting portion 702 includes the inclined surface 726 is illustrated. However, the fitting portion may not have the inclined surface which increases the thickness of the fitting portion as it approaches the lid structure.

In the above embodiment, the case where the width H1 of the main body portion 701 of the side spacer 700 is smaller than the width H2 of the second side surface 405 of the electrode assembly 400 is illustrated. However, the width of the main body portion may be equal to or greater than the width of the second side surface of the electrode assembly.

In the above embodiment, the case where the corner 703 of the thin portion 704 (the other end) in the main body portion 701 of the side spacer 700 is chamfered is illustrated. However, the corner of the other end in the main body portion may not be chamfered.

In the above embodiment, the case where the other end in the main body portion 701 of the side spacer 700 is accommodated in the second side surface 405 of the electrode assembly 400 is illustrated. However, the other end in the main body portion may not be accommodated in the second side surface of the electrode assembly.

In the above embodiment, the case where the insulating sheet 500 is joined to one end on the lid structure 180 side in the side spacer 700 is illustrated. However, the insulating sheet only needs to be joined to any place of the side spacer.

In the above embodiment, the case where the insulating sheet 500 covers the bottom surface 403 of the electrode assembly 400 and the pair of first side surfaces 404 is illustrated. However, the insulating sheet only needs to cover at least one first side surface of the electrode assembly. The insulating sheet may separately include a sheet which covers one of the pair of first side surfaces of the electrode assembly and a sheet which covers the other of the first side surfaces.

In the above embodiment, the case where the side spacer 700 has a flat plate shape is illustrated. However, the side spacer may have a curved plate shape.

### INDUSTRIAL APPLICABILITY

The present invention can be applied to an energy storage device, such as a lithium ion secondary battery, and the like.

### DESCRIPTION OF REFERENCE SIGNS

10: Energy storage device
100: Case
101: Case body
110: Lid body
110a, 110b, 120a, 125a, 130a, 135a, 140a, 150a: Through-hole
120, 130, 130B: Lower gasket (insulator)
120b, 130b: Engagement protrusion
121, 131, 131b: Engaging portion
122, 132: Reinforcing rib
124: Electrolyte solution filling port
125, 135: Upper gasket
126: Electrolyte solution filling plug
140: Positive electrode current collector (current collector)
150: Negative electrode current collector (current collector)
160: Bulging portion
180, 180B: Lid structure
200: Positive electrode terminal
300: Negative electrode terminal
310: Fastening portion
370, 380: Adhesive tape
400: Electrode assembly
401: Electrode assembly body
402: Top surface
403: Bottom surface
404: First side surface
405: Second side surface
415: Positive electrode bundling portion
425: Negative electrode bundling portion
500, 500A: Insulating sheet
501: Protruding piece
700, 700B, 700C: Side spacer (insulating member)
701: Main body portion
702: Fitting portion (thick portion)
702b, 702c: Fitting portion
703: Corner
704, 706: Thin portion
705, 707, 726: Inclined surface
708: Slit
710: Outer surface
721, 721b: Proximal end
722: Inclination portion
723: Wall portion
724: Holding portion (abutment portion)
725, 725b: Distal end
726b: Inclined surface
1311: Nipping surface
7251, 7251c: First portion
7252: Second portion
C: Joining region
H1, H2: Width
S, S1, S2, sb: Space

1. An energy storage device comprising:
an electrode assembly;
a case body containing the electrode assembly;
a lid structure having a lid body closing the case body; and
an insulating member disposed around the electrode assembly in the case body,
wherein one of the lid structure and the insulating member includes a space along an insertion direction with respect to the case body, and an other of the lid structure and the insulating member has a fitting portion which is abutted against the one of the lid structure and the insulating member in each of the insertion direction and an opposite direction of the insertion direction in the space and fitted in the space.

2. The energy storage device according to claim 1, wherein the electrode assembly is fixed to the insulating member.

3. The energy storage device according to claim 1, wherein a proximal end of the fitting portion is thicker than a distal end fitted in the space.

4. The energy storage device according to claim 1, further comprising a current collector electrically connected to the electrode assembly,
wherein the lid structure includes an insulator which insulates the lid body and the current collector,
the space is provided between the lid body and the insulator in the lid structure,
the insulating member includes the fitting portion, and the fitting portion is sandwiched between the lid body and the insulator in the space.

5. The energy storage device according to claim 4, wherein the insulating member includes a main body portion facing a side surface of the electrode assembly and having the fitting portion protruding from one end on a side of the lid structure, and the fitting portion has an abutment portion abutted against the lid structure in a protruding direction of the fitting portion.

6. The energy storage device according to claim 4, wherein in a state in which the fitting portion is not fitted in the space, a nipping surface of the insulator, which nips the fitting portion with the lid body, is inclined with respect to the insertion direction with an inclination where the space becomes smaller toward a distal end.

7. The energy storage device according to claim 4, wherein the nipping surface of the insulator, which nips the fitting portion with the lid body, nips the fitting portion with an inclination where the nipping surface approaches the lid body toward the distal end.
